(19) United States
(12) Patent Application Publication
(10) Pub. No.: US 2025/0036853 A1
(43) Pub. Date: Jan. 30, 2025

(54) SYSTEM AND METHOD PROVIDING SPECIALIZED SIZE UNITS IN RESPONSIVE EDITING

(71) Applicant: Wix.com Ltd., Tel Aviv (IL)

(72) Inventors: Itay SHTEKEL, Ramat Gan (IL); Daniel GENDELMAN, Ramat Gan (IL); Rafi ELIASAF, Tel Aviv (IL); Andrey MOISEEV, Holon (IL); Erez REUVEN, Ra'anana (IL); Matan COHEN, Givatayim (IL); Tomer KRUVI, Tel Aviv (IL)

(21) Appl. No.: 18/782,091

(22) Filed: Jul. 24, 2024

Related U.S. Application Data
(60) Provisional application No. 63/515,142, filed on Jul. 24, 2023.
(60) Provisional application No. 63/559,240, filed on Feb. 29, 2024.

(51) Int. Cl. G06F 40/106; G06F 16/958; G06F 40/109; G06F 40/14; G06F 40/154; G06F 40/166; G06F 40/197

(52) U.S. Cl. CPC G06F 40/106; G06F 16/986; G06F 40/109; G06F 40/14; G06F 40/154; G06F 40/166; G06F 40/197

(57) ABSTRACT

A website building system (WBS) includes an editor to enable a designer of the WBS to create and edit a website on a first sized viewport, the website having at least one component having at least one property with a display pixel value for a measurement of the first sized viewport represented as a designer intent responsive pixel (DIRP), the editor to save a representation of the website according to an original layout of the website, a scaling pixel handler to render the representation onto a second sized viewport and to display the at least one component proportionally as scaled version of the DIRP according to a measurement of the second sized viewport; and where the rendered representation maintains the original layout.

### CROSS REFERENCE TO RELATED APPLICATIONS

This application claims priority from U.S. provisional patent applications 63/515,142, filed Jul. 24, 2023, and 63/559,240, filed Feb. 29, 2024, both of which are incorporated herein by reference.

### FIELD OF THE INVENTION

The present invention relates to websites generally and to display in particular.

### BACKGROUND OF THE INVENTION

Website building systems (WBS) and other visual design systems are used by both novices and professionals to create interactive websites. Existing WBSs are based on a visual editing model and most WBSs typically provide multiple templates, with a template possibly including a complete sample website, a website section, a single page, or a section of a page.

WBS users (also known as designers, subscribers, subscribing users or site editors) may design the website and the website's end-users (the “users of users”) may access the websites created by the users.

A WBS may be a standalone system or may be embedded inside a larger editing system. It may also be on-line (i.e., applications are edited and stored on a server), off-line or partially on-line (with web sites being edited locally but uploaded to a central server for publishing). The WBS may use an internal data architecture to store WBS based sites and this architecture may organize the handled sites' internal data and elements inside the system. This architecture may be different from the external view of the site (as seen, for example, by the end-users). It is also typically different from the way the HTML pages sent to the browser are organized.

For example, the internal data architecture may contain additional properties for each element in the page (creator, creation time, access permissions, link to templates, SEO (search engine optimization) related information etc.) which are relevant for the editing and maintenance of the site in the WBS but are not externally visible to end-users (or even to some editing users). The WBS may implement some of its functionality (including both editing and run-time functionality) on a server or server set, and some of its functionality on client elements. The WBS may also determine dynamically whether to perform some functionality on the server or on the client platform.

A WBS typically handles the creation and editing of visually designed applications (such as a website) consisting of pages, containers, and components. Pages may be separately displayed and contain components. Components may include containers as well as atomic components.

The WBS may also support hierarchical arrangements of components using atomic components (text, image, shape, video etc.) as well as various types of container components which contain other components (e.g., regular containers, single-page containers, multi-page containers, gallery containers etc.). The sub-pages contained inside a container component are referred to as mini-pages, and each of which may contain multiple components. Some container components may display just one of the mini-pages at a time, while others may display multiple mini-pages simultaneously.

The components may be content-less or have internal content. An example of the first category is a star-shape component, which does not have any internal content (though it has color, size, position, attributes, and other parameters). An example of the second category is a text paragraph component, whose internal content includes the internal text as well as font, formatting, and layout information (which is also part of the content rather than being attributes of the component). This content may, of course, vary from one instance of the text paragraph component to another. Components which have content are often referred to as fields (e.g., a “text field”).

Pages may use templates, general page templates or component templates. Specific cases for templates include the use of an application master page containing components replicated in all other regular pages, and the use of an application header or footer (which repeat on all pages). Templates may be used for the complete page or for page sections. The WBS may provide inheritance between templates, pages, or components, possibly including multi-level inheritance, multiple inheritance and diamond inheritance (i.e., A inherits from B and C and both B and C inherit from D).

The visual arrangement of components inside a page is called a layout. The WBS may also support dynamic layout processing, a process whereby the editing of a given component (or other changes affecting it such as externally driven content change) may affect other components, as further described in U.S. Pat. No. 10,185,703 entitled “Website Design System Integrating Dynamic Layout and Dynamic Content” granted 22 Jan. 2019, commonly owned by the Applicant and incorporated herein by reference. It describes how a website may be created based on visual editing or automatic generation based on collected business knowledge.

A WBS may be extended using add-on applications such as a third party application and its components (TPAs), list applications (such as discussed in US Patent Publication No. US 2014/0282218 entitled “WBS Integrating Data Lists with Dynamic Customization and Adaptation” published 18 Sep. 2014, commonly owned by the Applicant and incorporated herein by reference) and WBS configurable applications (WCAs, such as described in US Patent Publication No. 2020/0151226 entitled “System And Method for Creation and Handling of Configurable Applications for Website Building Systems” published 14 May 2020 commonly owned by the Applicant and incorporated herein by reference). These third party applications and list applications may be added and integrated into designed websites.

Typical site creation may be based on a number of models, including a visual editing model (in which the user edits a previously created site) and an automatic site generation model or a combination thereof as illustrated in FIG. 1 to which reference is now made and is described in U.S. Pat. No. 10,073,923 entitled “System and Method for the Creation and Update of Hierarchical Websites Based on Collected Business Knowledge” granted 11 Sep. 2018, commonly owned by the Applicant and incorporated herein by reference.

It will be appreciated that throughout the specification, the acronym WBS may be used to represent a website building system. FIG. 1 illustrates a system 100 that comprises a typical WBS 2 in communication with client systems operated by WBS vendor staff 61, a site designer 62 (i.e., a user), a site user 63 (i.e., user of user) and with external systems 70. WBS 2 may further comprise a WBS site manager 10, an object marketplace 15, a WBS RT (runtime) server 20, a WBS editor 30, a site generation system 40 and a WBS content management system (CMS) 50.

It will be appreciated that in alternative embodiments of the invention, system 100 may also be any visual design system or non-web platform such as ab embedded display engine in a mobile application creation system.

Automatic responsive behavior in a website refers to its ability to automatically adjust the layout, design, and content of a website to ensure optimal display and functionality across various devices and screen sizes. Users often seek this feature as it enables their websites to provide a seamless and user-friendly experience for visitors, regardless of the device they are using. Responsive behavior for a website is further discussed in U.S. Pat. No. 10,984,177 entitled “System and Method Providing Responsive Editing and Viewing, Integrating Hierarchical Fluid Components and Dynamic Layout” granted Nov. 26, 2020, commonly owned by the Applicant and incorporated herein by reference. Transforming a website display across different screen sizes is further discussed in U.S. Pat. No. 10,176,154 entitled “System and Method for Automated Conversion of Interactive Sites and Applications to Support Mobile and Other Display Environments”, granted Jan. 8, 2019, commonly owned by the Applicant and incorporated herein by reference. Webpages are designed to display content based on pixel dimensions and graphic elements are displayed according to their pixel size. As a result (for example), an image that has a 20×20 pixel size may appear bigger on a low resolution display since the display requires more space to display the pixels. Pixels are typically measured using the unit px.

CSS (cascading style sheets) is known in the art a style sheet language used for specifying the presentation and styling of a website written in a markup language such as HTML or XML During the website rendering stage, the browser converts the CSS into a visual representation for display.

### SUMMARY OF THE PRESENT INVENTION

There is therefore provided, in accordance with a preferred embodiment of the present invention, a website building system (WBS). The system includes an editor, a scaling pixel handler. The editor enables a designer of the WBS to create and edit a website on a first sized viewport, the website having at least one component having at least one property with a display pixel value for a measurement of the first sized viewport represented as a designer intent responsive pixel (DIRP), the editor saves a representation of the website according to an original layout of the website. The scaling pixel handler renders the representation onto a second sized viewport and displays the at least one component proportionally as scaled version of the DIRP according to a measurement of the second sized viewport, where the rendered representation maintains the original layout.

Moreover, in accordance with a preferred embodiment of the present invention, the at least one component includes at least one of: page, a section, a mini-page, a regular container, a single-page container, a multi-page container and a gallery container.

Further, in accordance with a preferred embodiment of the present invention, the editor includes a visual editor to enable the editing using a stage and panels, and a document converter to save the representation using a data representation language.

Still further, in accordance with a preferred embodiment of the present invention, the scaling pixel handler includes a document renderer to convert the representation to CSS properties for the display according to the original layout, and a machine learning (ML)/artificial intelligence (AI) engine to provide recommendations and overrides for the document renderer.

Additionally, in accordance with a preferred embodiment of the present invention, the document renderer includes a designer intent responsive pixel (DIRP) calculator to scale the DIRPs according to the measurement of the second sized viewport.

Moreover, in accordance with a preferred embodiment of the present invention, the measurement is width or height.

Further, in accordance with a preferred embodiment of the present invention, the at least one property is at least one of: font size, corner radius, border width and box shadow.

Still further, in accordance with a preferred embodiment of the present invention, the original layout includes a typography of the website.

There is therefore provided, in accordance with a preferred embodiment of the present invention, a method for a website building system (WBS). The method includes enabling a designer of the WBS to create and edit a website on a first sized viewport, the website having at least one component having at least one property with a display pixel value for a measurement of the first sized viewport represented as a designer intent responsive pixel (DIRP), saving a representation of the website according to an original layout of the website, rendering the representation onto a second sized viewport, displaying the at least one component proportionally as scaled version of the DIRP according to a measurement of the second sized viewport, where the rendered representation maintains the original layout.

Moreover, in accordance with a preferred embodiment of the present invention, the at least one component includes at least one of: page, a section, a mini-page, a regular container, a single-page container, a multi-page container and a gallery container.

Further, in accordance with a preferred embodiment of the present invention, the enabling a designer includes enabling editing using a stage and panels and saving the representation using a data representation language.

Still further, in accordance with a preferred embodiment of the present invention, the rendering includes converting the representation to CSS properties for the display according to the original layout and using machine learning (ML)/artificial intelligence (AI) engine to provide recommendations and overrides for the converting.

Additionally, in accordance with a preferred embodiment of the present invention, the converting includes a designer intent responsive pixel (DIRP) calculator to scale the DIRPs according to the measurement of the second sized viewport.

Moreover, in accordance with a preferred embodiment of the present invention, the measurement is width or height.

Further, in accordance with a preferred embodiment of the present invention, the at least one property is at least one of: font size, corner radius, border width and box shadow.

Still further, in accordance with a preferred embodiment of the present invention, the original layout includes a typography of the website.

There is therefore provided, in accordance with a preferred embodiment of the present invention, a system for providing specialized size units in responsive editing. The system includes a scaling pixel handler. The scaling pixel handler is configured to receive a document defining a website layout using designer intent responsive pixels (DIRPs), where each DIRP is associated with a reference viewport size, render the document into Cascading Style Sheets (CSS) by converting the DIRPs to CSS units based at least on a current viewport size, and output the rendered CSS for display of the website layout across different viewport sizes while preserving designer intent and typography consistency.

Moreover, in accordance with a preferred embodiment of the present invention, the scaling pixel handler is further configured to receive a user input specifying a custom viewport size, and dynamically update the rendered CSS based on the custom viewport size.

Further, in accordance with a preferred embodiment of the present invention, dynamically updating the rendered CSS includes recalculating the conversion of DIRPs to CSS units based on a ratio between the custom viewport size and the reference viewport size.

Still further, in accordance with a preferred embodiment of the present invention, the scaling pixel handler is further configured to maintain a consistent typography scale across different viewport sizes by applying a scaling factor to font sizes defined using DIRPs.

There is therefore provided, in accordance with a preferred embodiment of the present invention, a system for providing specialized size units in responsive editing. The system includes a scaling pixel handler and a document renderer. The scaling pixel handler is configured to implement designer intent responsive pixels (DIRPs) for rendering website components on different viewports. The document renderer is configured to convert DIRPs to Cascading Style Sheet (CSS) properties for displaying the website components.

There is therefore provided, in accordance with a preferred embodiment of the present invention, a method for a website building system. The method includes receiving a designer input for a website component, converting the designer input into a designer intent responsive pixel (DIRP) value, storing the DIRP value with a reference viewport size, and rendering the website component using the DIRP value and the reference viewport size.

There is therefore provided, in accordance with a preferred embodiment of the present invention, a website building system. The system includes a visual editor, a document converter, and a document renderer. The visual editor is configured to receive designer inputs for creating website components. The document converter is configured to convert the designer inputs into designer intent responsive pixel (DIRP) values. The document renderer is configured to render the website components using the DIRP values and associated reference viewport size.

There is therefore provided, in accordance with a preferred embodiment of the present invention, a method for rendering website components. The method includes retrieving a designer intent responsive pixel (DIRP) value and a reference viewport size for a website component, calculating a Cascading Style Sheet (CSS) value based at least on the DIRP value and the reference viewport size, and rendering the website component using the calculated CSS value.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a website building system for the creation and update of hierarchical websites;

FIG. 2 is a schematic illustration of a system for handling responsive editing using designer intent responsive pixels, constructed and operative in accordance with the present invention;

FIG. 3 is a schematic illustration of the use of designer intent responsive pixels, constructed and operative in accordance with the present invention;

FIG. 4 is a schematic illustration of the elements of the system of FIG. 2, constructed and operative in accordance with the present invention;

FIG. 5 is a schematic illustration of example code for the definition of designer intent responsive pixels, constructed and operative in accordance with the present invention;

FIG. 6 is a schematic illustration of an example flow of activity for the system of FIG. 2; constructed and operative in accordance with the present invention;

FIGS. 7A and 7B are schematic illustrations of the implementation of different editing activities using the system of FIG. 2, constructed and operative in accordance with the present invention.

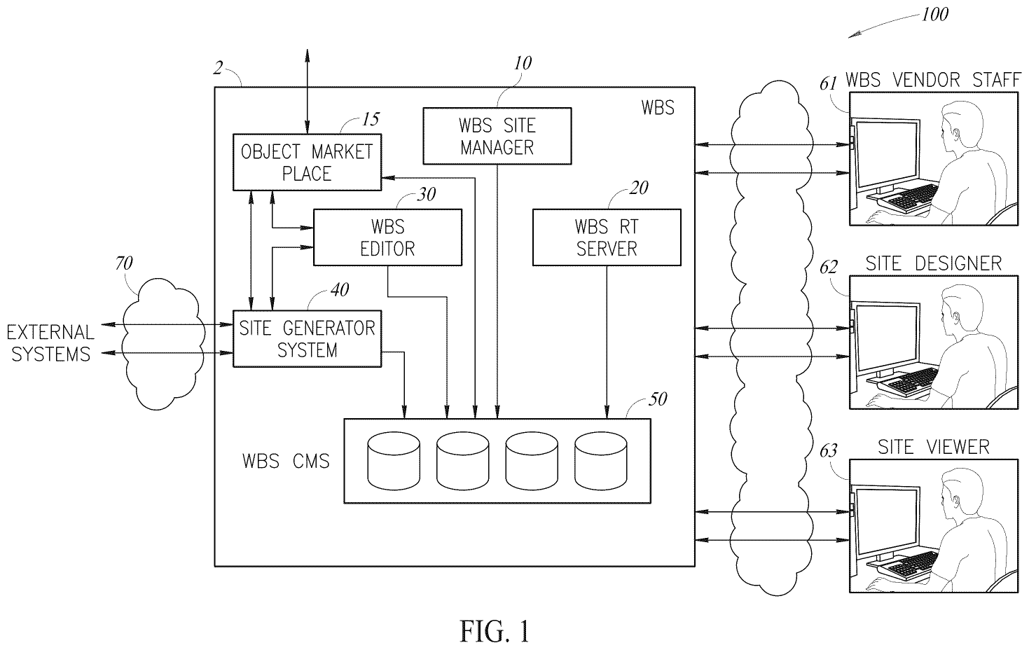

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that the automatic responsive behavior as described herein above may provide designers the ability to provide a seamless and user-friendly experience for visitors to their websites, regardless of the device they are using. The incorporation of responsive behavior allows websites that are built using a WBS for a particular screen or display size to adapt their display to other devices of differing sizes such as smartphones and tablets. This ensures that viewers or end-users accessing a website on a (for example) smaller screen, can easily navigate, read, and interact with the content.

Automatic responsiveness also helps maintain consistent branding and design elements across devices. Responsive behavior can ensure that a website's visual identity including logos, colors, fonts, and images remain intact and appealing, contributing to a professional and cohesive online presence.

Applicant has further realized websites that can automatically adjust to different screen sizes provide enhanced useability. Features such as menus, buttons and forms can be optimized for touchscreens making it easier for viewers to navigate and interact with the site leading to a positive viewer experience.

Furthermore, automatic responsive behavior simplifies the website development process. Designers can avoid the need to create multiple versions of the same site for different devices, saving time and resources such as processing power.

Applicants have also realized that the implementation of automatic responsive behavior by a website designer typically requires knowledge and understanding of responsive layout mechanics such as understanding what types of responsive behaviors can be achieved (e.g., fixed height and relative width, how to change size according to screen size breakpoints, how to keep aspect ratio, relativity to a container, etc.) and the available units of measurements, how they behave, relative to the size of what etc.

Other considerations may include which properties of the elements are modifiable, which units of measurements are supported for each property and how to design a layout from the available units and behaviors.

Applicant has realized that instead of using multiple breakpoints, site editing should have a single screen reference width per breakpoint (“image” design per breakpoint), and all other non-referenced screen widths should keep the same design, scaled proportionally without breaking. Websites typically have “themed texts” that have a global definition that could easily break if they are implicitly and automatically scaled. It is desirable to keep the consistency of the typography or original layout of the website, which typically reflects user intent. Therefore, when a website is created on a large screen and is then viewed a smaller screen (or stage when being edited), the website will still have the same design, scaled to the same proportions thus preserving user design intent and typography.

Applicant has also realized that such an improvement to responsive editing may be implemented using scale proportionally for CSS properties so that components are scaled properly on live sites while keeping typographical consistency with the ability to easily be edited. Scale proportionality could be applied to various properties such as font size, corner radius, border width, box shadow etc.

Scale proportionality allows designers to design and edit their websites in a pixel perfect WYSIWYG (what you see is what you get) manner with the result of a design that is adaptive to different viewport sizes while preserving typographical consistency. It may be implemented within a system that provides a visual editing experience (such as image editing software) while outputting responsive websites that allow for the configuration of CSS properties. The scaling pixel solution as described herein above should further coexist with other editor features such as other responsive design features, breakpoints and design between the breakpoints and cascading style behavior.

As discussed herein above, CSS is used to define the display of a website. In CSS, sizes such as width or height of a given object or component, are defined either with a keyword, or by a combination of a number with a unit, or both.

Keywords can refer to behavior in relation to the content (e.g., “auto”) of a component or a function (e.g., “calc”) based on various variables and parameters.

Unit refers to various sizes and measurements to be multiplied to get specific sizes (e.g., “13 px”, “3%”, “7 em”).

Specific references for the units may be sizes of (as an example) font (e.g., “em”), viewport (e.g., “svw”, “vh”), container-queries (e.g. “50 cqw” is half of the size of the closest container marked with specific “container-type”) or absolute length (e.g., “10 px”) specified in physical pixels.

Applicant has further realized that the obvious candidates for responsive design using scaling are viewport units and container queries. However, both methods have substantial disadvantages. Viewport units may have local and global hard coded reference points which cannot be changed. For example, their sizes cannot be overruled based on context (e.g., embedding parts of a website in a different website).

Container queries apply styles to features based on viewport size. One such CSS property or unit is cqw. For example, 1 cqw stands for 1% of a query container's width. Container queries require containment context so that the browser knows that the dimensions of the container may change. An example is a container with a title component and some text. By defining a container-type property such as container type: inline size, the browser can apply styles to elements of the container based on the size of its nearest ancestor within a containment context. A query can apply for a larger font size for the title if the container width is increased. Therefore, the container can be used in multiple areas of a page without needing to know its exact location. Also, any descendants within the container may also have a matching size accordingly without the need to know the exact container size.

Query containers typically need the measurements of a reference container for a WYSIWYG editing experience (other than the edited component itself). They also require computation to provide WYSIWYG editing experience, since their size is determined by a relationship to a different component and thus needs to be re-evaluated to apply a change. Furthermore, query containers need to be searched and it is difficult to maintain consistency of the typography on the website due to multiple reference points. It will be appreciated that the term “query container” is one whose size is based on a parent “queried container”/“reference container”, i.e., a parent container that is queried for its size to determine the descendant's size or the container that determines how many pixels will equal 1 cwq for all its descendants.

For example, to define the size of a descendant using a container query in a WYSIWYG editor, the editor needs to know the size of the container so that it may recursively look for the closest ancestor container that is defined as a “queried container” which sizes descendants according to changes and/or edits.

Another CSS property is viewport width (vw). The viewport or display width is divided into 100 equal parts and 1 vw is equivalent to 1% of the viewport width. Therefore, if the number of pixels for a particular layout is known (for example 1440 px), 100 vw=1440 px and 1 vw=1440 px/100=14.4 pixels.

Applicant has further realized that it is also hard to maintain typography and user intent when performing heuristics (heuristics are needed since designer mouse input is in pixels which need to be converted to actual units).

The designer intent responsive pixel (DIRP) definition is the pixel size (measured in spx—scaling pixel) in a specific screen width (typically the screen with which the website is built), that is then scaled proportionally to other screen widths (e.g., if 16 spx are defined for font size 16 px for screen width 1000 px, on a 2000 px screen, the actual rendered font size would be 32 px). DIRP/spx may be introduced as a new measurement unit.

Thus, by defining a new pixel value in relation to a viewport size (DIRP as described herein above), the need to measure rendered values during editing and viewing can be saved, thus enabling offline editing (e.g., by editing the page definition (HTML/CSS) manually as a text file). This may also save on potentially heavy computer processing on the client or server or both Since there is no need for the back-and-forth conversion between the client and server which would be required if relationship to viewport size was not known.

It may also allow for various behaviors to be applied to the same property, such as a global minimum size, for accessibility purposes and allow for the change of behavior according to context and situation (such as embedding the components in a non-scaling container, or completely outside of the website).

The DIRP measurement (which may be measured in spx) may also enable high flexibility in configuration of states of components such as at different breakpoints, hover, clicked etc. (e.g., behavior in desktop-tablet-mobile could be scaled-fixed-scaled accordingly) as well as maintain themed typography consistency across fixed and scaling properties (i.e., globally set font sizes).

Another advantage may be forward compatibility with future CSS units and other features (due to user intent being saved rather than specific implementation) and backwards compatibility to old browsers (same user intent could have different implementation for older browsers). This may vary between editing and viewing.

Further advantages may be different scaling behaviors that can be applied to different properties (high granularity and configurability) and the provision of a smooth editing experience, due to result of on-stage behavior having the same unit value (in px) as the actual set value in the document (in spx). It will be appreciated that sometimes browsers present jumpy behavior while dragging containers because of the pixel calculation. If sub pixels are calculated and rounded to the nearest integer, jumpiness may happen.

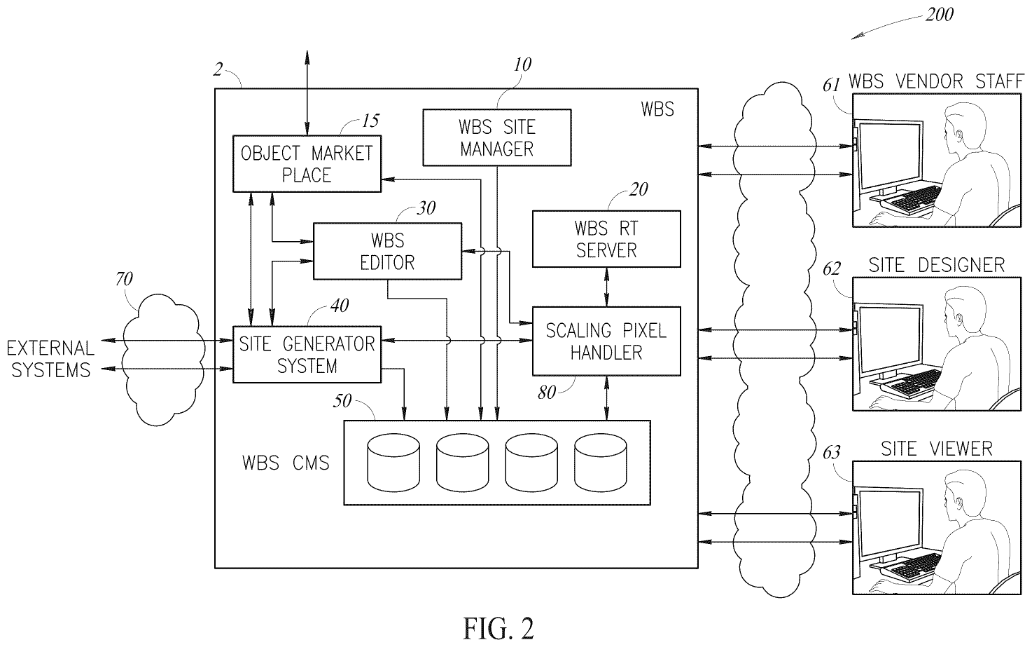

Reference is now made to FIG. 2 which illustrates a WBS 200 comprising a scaling pixel handler 80 for the implementation of responsive editing using designer intent responsive pixels (DIRPs) according to an embodiment of the present invention. WBS 200 may comprise the elements of system 100 as described in U.S. Pat. No. 10,073,923 (as well as any sub elements) in conjunction with scaling pixel handler 80. In an alternative embodiment, scaling pixel handler 80 may be standalone from a WBS or may function online (i.e., applications are edited and stored on a server or server set), offline, or partially online (with websites being edited locally but uploaded to a central server for publishing).

It will be appreciated that the functionality of system 200 may include or be specific to client side or server-side activities. Functionality may be performed on a client, a server or be divided between the two.

Scaling pixel handler 80 may handle rendering of DIRPs for viewing on different viewports by providing an abstraction to the CSS properties for the website in question. The conversion to CSS may therefore depend on context and requirements but the final rendered website may preserve typography and designer intent.

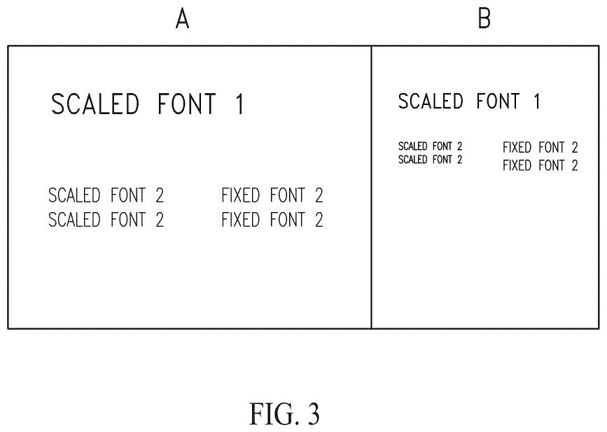

For example, a designer may create or edit a website on a desktop with a large viewport. When the website is viewed on a smaller viewport (such as a mobile device), the website will have the same design, scaled to the same proportions as intended by the designer. Reference is now made to FIG. 3 which illustrates the same website page display on two differently sized viewports (A and B accordingly). As discussed herein above, scale proportionally may be applied for font size, corner radius, border width and box shadow and more.

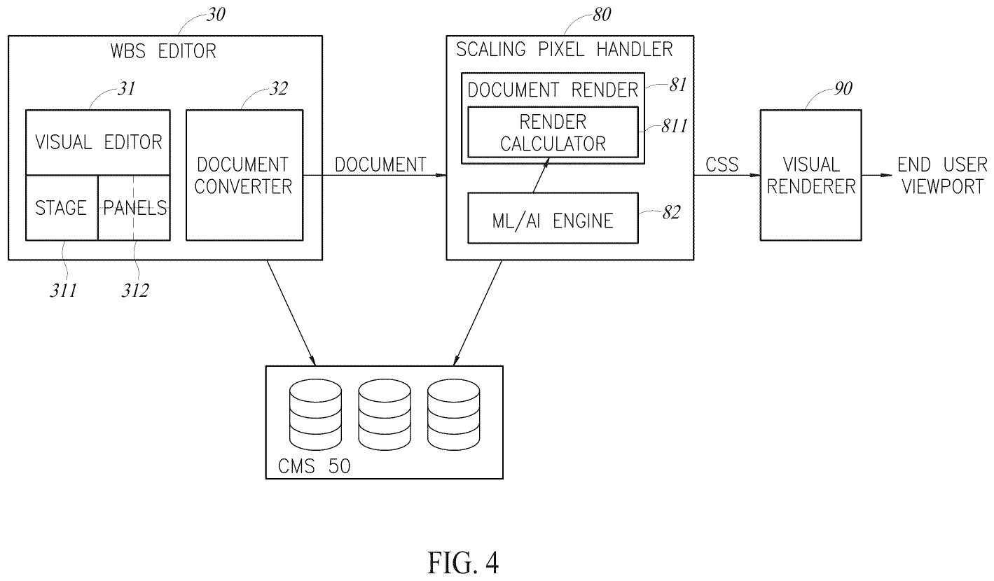

Reference is now made to FIG. 4 which illustrates the elements of WBS editor 30 and scaling pixel handler 80. WBS editor may comprise a visual editor 31 and a document converter 32. Scaling pixel handler 80 may further comprise a document renderer 81 and a ML/AI (machine learning/artificial intelligence) engine 82. Document renderer 81 may further comprise a DIRP (designer intent responsive pixel) calculator 811. The functionality of these elements is described in more detail herein below.

Visual renderer 90 may be the browser renderer which converts the calculated CSS into a visual display for the end user or website visitor. It will be appreciated that in non-WBS embodiments as described herein above, rendering may be performed using a browser engine or other similar mechanism. Both WBS editor 30 and scaling pixel handler 80 may be in communication with CMS 50. CMS 50 may be implemented using a single database or multiple databases, based on one or more servers or server farms. CMS 50 may hold all forms of content and layout pertinent to website building such as components (text, images buttons etc.) together with attributes and properties used to configure the website components such as font size, image source, border width etc.

CMS 50 may further store WBS designer information such as designer parameters, editing history of designers, business intelligence related to designers and websites etc.

A designer may use visual editor 31 to visually design a website comprising components from CMS 50. It will be appreciated that the size of the viewport or display that he uses may be defined as the reference display. Visual editor 31 may comprise of an editing stage 311 and different panels 312. Editing stage 311 may be the area where the designer can see and edit his website in a WYSIWYG manner. Panels 312 are the areas where the designer can configure various properties of the website components and data items.

During the editor session, input is received from the designer through stage 311 or panels 312. The input from stage 311 is usually done using drag and drop, resize, and keyboard input. The input from panels 312 is usually done using text input, dropdowns, and other UI (user interface) elements.

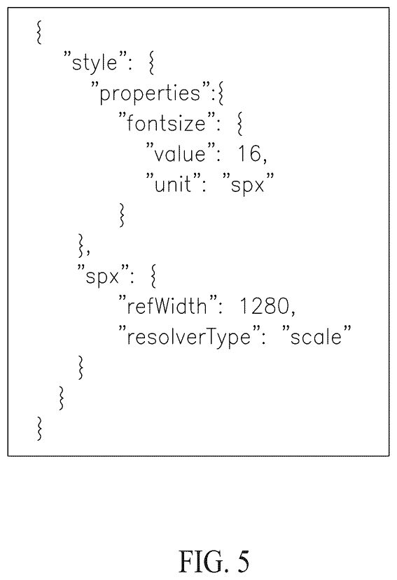

When a user adds a website component to the page, the component may have scaling or fixed properties. The scaling behavior can be set by the designer or can be set by default by the WBS vendor. When a scaling behavior is set, the rendered pixel value of the property (px) is saved along with the reference viewport size or other reference size as a DIRP or spx value. Reference is now made to FIG. 5 which illustrates exemplary representative code for declaring a website component. It will be appreciated that in this scenario, the font size was 16 pixels when the designer set it on the viewport reference size of 1280 pixels and that it is set to be scaled proportionately according to the rendered screen size.

It will also be appreciated that any manipulation of a component will update both the px value (the actual pixels displayed) and the reference size. The manipulation may be applied (for example) within a context (e.g., scaling behavior can be saved globally; or per breakpoint; or per state (such as hover, clicked, hover on container, etc.); or per n-th item of a list; or any other context that can be defined). As discussed in more detail herein below, document renderer 81 may use the reference size and the DIRP (spx) to decide the actual CSS implementation of the property. Document renderer 81 may decide to use the DIRP or to use a fixed value, depending on the context and the scaling behavior. Document renderer 81 may further decide to implement the CSS scaling behavior using the cqw unit, or may even pre-calculate the value, which could be more efficient for “live” website rendering (i.e., publicly available, and not inside the editor).

Furthermore, typography may be kept consistent by determining that font properties are not scaled proportionally but are fixed to the value defined in the DIRP or be fixed relative to some computation of the initial viewpoint size.

When the designer has finished editing/creating his site, document converter 32 may save the website in document format using a data representation language such as JSON or XML. The document may contain a suitable representation of the components used as well as designer heuristics and intent such as chosen fonts, colors, animation, location on the display and relationships between components.

It will be appreciated that document converter 32 may translate every input from the designer into an action that is applied to the document. Depending on the action, the translation can involve various heuristics and algorithms. For example, manipulation from on-stage drag and drop over a component with data item that includes “percent” units, needs to have a common denominator between the mouse movement vector and the data item value, which can be done by measuring the rendered value of the data item, applying the vector and then converting back to the data item unit.

It will also be appreciated that during an editing session, the manipulation of website components may be done in pixels using DIRPs i.e., display pixel values with a reference viewport size. No further measurement or heuristics are needed, since both mouse movement vector inputs and keyboard inputs can be pixel based and thus have a common measurement unit with the saved values. Thus, mathematical processing may be performed on component sizes (such as adding 10 px to the width of a component) without the need for heuristics or any unit conversion logic. The DIRPs may be saved by document converter 32 in the document along with the reference viewport size, to complete the context of the user intent. Alternatively, the DIRPs may be saved in a separate repository associated with the document.

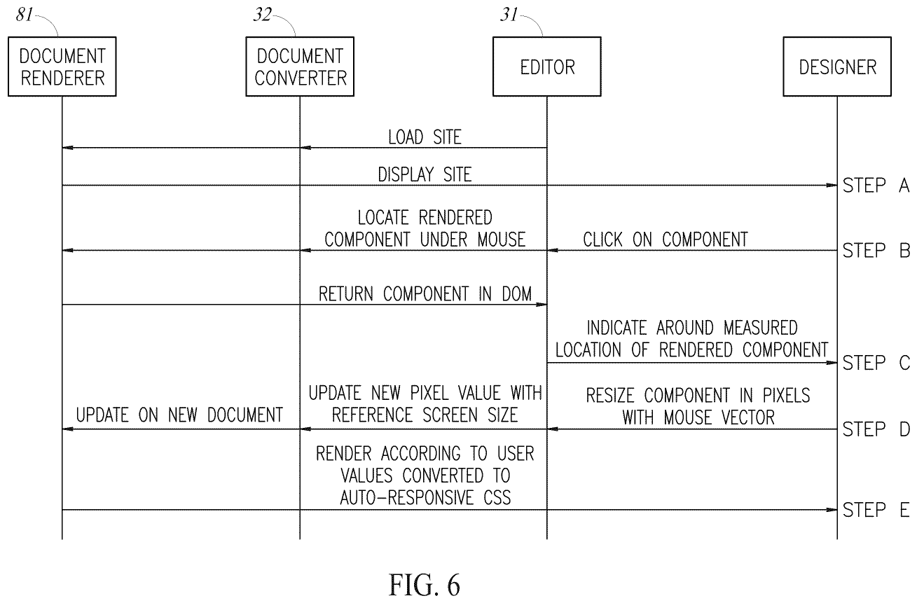

Reference is made to FIG. 6 which illustrates an example flow of activity for system 200. As can be seen, a designer creates a website which is loaded, rendered, and displayed (step a). If a designer wants to make an edit, he can click on a component which is rendered according to his viewport size (step b). Since components are rendered as complex HTML, editor 31 may need to locate any relevant components the designer wants to edit from any previously rendered components. After a relevant component has been determined, editor 31 may highlight it as “selected” (e.g., place a border around it) (step c). It will be appreciated that editor 31 may locate components by abstracting the rendered document object model (DOM) back to relevant components written in the document representation language.

For example, a JSON component that is a button, may be rendered as a DOM:
<div class=“some_style” id=“component_id”>
<button>text</button>
</div>

In this example, the component is implemented using two nested DOM elements when editor 31 instructs document converter 32 which in turn delegates the questions to document renderer 81. Document renderer 81 may use a native browser API to determine the DOM elements under the mouse. The result may be two DOM elements, one of which is the root element of the button, and the other is an implementation detail of the rendering. Therefore, document renderer 81 needs to understand from the rendered DOM, which is which, and return only abstract expression of the components. In this scenario it may read two DOM elements “[div, button]” and could return “[‘component_id’].”

In steps d and e, the designer may resize the component by updating the pixel values using a mouse vector and the new values are saved and rendered to CSS for further viewing. In this scenario, the pixel value is provided using input from the mouse (which is always in pixels) to set the value of the property, which is then saved as DIRP.

Document renderer 81 may render the document into CSS using the reference viewport size and DIRPs to decide the actual CSS implementation for optimal responsive behavior.

ML/AI engine 82 may provide recommendations to document renderer 81 based on analysis of data stored in CMS 50 and update the created CSS. It will be appreciated that ML/AI engine 82 may be trained on and understand website displays and recommend properties per section or editing panels of the website for rendering while keeping context. ML/AI engine 82 may also override properties and values as discussed in more detail herein below.

AI/ML engine 82 may use generative AI based algorithms for proposing assets/resources to designers according to information on other designers internal and external to WBS 200 (and subject to all relevant laws, regulation, and TP and other property rights). AI/ML engine 82 may further train machine learning models to provide support for the functionality of the other elements of scaling pixel handler 80.

It will be appreciated that the terms “trained machine learning model,” “machine learning model,” “model,” or “one or more models” refer to a machine learning or deep learning task or mechanism. Machine learning is a method used to devise complex models and algorithms that lend themselves to prediction. A machine learning model is a computer-implemented algorithm that may learn from data with or without relying on rules-based programming. These models enable reliable, repeatable decisions and results and uncovering of hidden insights through machine-based learning from historical relationships and trends in the data. In some embodiments, the machine learning model is a clustering model, a regression model, a neural network, a random forest, a decision tree model, a classification model, or the like.

A machine learning model is initially fitted or trained on a training dataset (e.g., a set of examples used to fit the parameters of the model). The model may be trained on the training dataset using supervised or unsupervised learning. The model is run with the training dataset and produces a result, which is then compared with a target, for each input vector in the training dataset. Based on the result of the comparison and the specific learning algorithm being used, the parameters of the model are adjusted. The model fitting may include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g., the number of hidden units in a neural network). In some embodiments, the model can be trained and/or trained in real-time (e.g., online training) while in use.

The machine learning models, one or more models, trained machine learning models, legitimacy prediction models, improper dispute prediction models, resource volume prediction models, and disputed network transaction prediction models as described above may make use of multiple ML engines, e.g., for analysis, recommendation generating, transformation, and other needs.

AI/ML engine 82 may train different ML models for different needs and different ML-based engines. AI/ML engine 82 may generate new models (based on gathered training data) and may evaluate their performance against the existing models. Training data may include any of the gathered information, as well as information on actions performed based on the various recommendations.

The ML models may be any suitable model for the task or activity implemented by each ML-based engine. Machine learning models are known in the art and are typically some forms of neural network. The term refers to the ability of systems to recognize patterns based on existing algorithms and data sets to provide solution concepts. The more they are trained, the greater knowledge they develop.

The underlying ML models may be learning models (supervised or unsupervised). As examples, such algorithms may be prediction (e.g., linear regression) algorithms, classification (e.g., decision trees, k-nearest neighbors) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders, transformer-based), models combining planning with other models (e.g., PDDL-based), or Generative models (e.g., GANs, diffusion-based models).

Alternatively, ML models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks, diffusion-based or auto-encoders) to generate definitions and elements.

In various embodiments, the ML models may undergo a training or learning phase before they are released into a production or runtime phase or may begin operation with models from existing systems or models. During a training or learning phase, the ML models may be tuned to focus on specific variables, to reduce error margins, or to otherwise optimize their performance. The ML models may initially receive input from a wide variety of data, such as the gathered data described herein.

In various embodiments and when appropriate for the particular task, one or more of the ML models may be implemented with rule-based systems, such as an expert system or a hybrid intelligent system that incorporates multiple AI techniques.

A rule-based system is used to store and manipulate knowledge to interpret information in a useful way. It is often used in artificial intelligence applications and research. Rule-based systems constructed using automatic rule inference, such as rule-based machine learning, may be included in this system type. An example rule-based system is a domain-specific expert system that uses rules to make deductions or choices. For example, an expert system might help a doctor choose the correct diagnosis based on a cluster of symptoms or select tactical moves to play a game. Rule-based systems can be used to perform lexical analysis to compile or interpret computer programs, or in natural language processing. Rule-based programming attempts to derive execution instructions from a starting set of data and rules.

A hybrid intelligent system employs, in parallel, a combination of methods and techniques from artificial intelligence subfields, such as: neuro-symbolic systems, neuro-fuzzy systems, hybrid connectionist-symbolic models; fuzzy expert systems; connectionist expert systems, evolutionary neural networks, genetic fuzzy systems, rough fuzzy hybridization, and/or reinforcement learning with fuzzy, neural, or evolutionary methods as well as symbolic reasoning methods.

An example hybrid is a hierarchical control system in which the lowest, reactive layers are sub-symbolic. The higher layers, having relaxed time constraints, are capable of reasoning from an abstract world model and performing planning. Intelligent systems usually rely on hybrid reasoning processes, which include induction, deduction, abduction, and reasoning by analogy.

Document renderer 81 may decide to use the spx value as saved or to use a fixed value, depending on the context and the scaling behavior. As discussed herein above, document renderer 81 may decide to implement the CSS scaling behavior using the cqw unit, such as: font-size: calc(var(−−font-size)*100 cqw/var(−−ref-width)).

DIRP calculator 811 may pre-calculate the CSS value for scaling behavior, which could be more efficient for “live” website rendering (i.e., publicly available, and not inside editor 30).

It will be appreciated that DIRP calculator 811 may use the current viewport width as a reference size, which is already given (either by the default state or set by the designer). DIRP calculator 811 may determine the container width reference in DIRPS for the reference screen width and update CSS variables (along with the container layout) if needed.

It will also be appreciated that DIRP calculator 811 may implement DIRPs in multiple ways. For example, DIRP calculator 811 may use the CSS calc( ) function used to calculate measurements that need to be done in real time. DIRP calculator 811 may keep the ratio between 100 cqw and the measured width according to the stored designer intent rather than the actual implementation i.e., the sizes and ratios that the designer saw on the screen width he was using while creating or editing his website. Thus, document renderer 81 can infer which component/container size to apply to ensure compatibility on all screen sizes and reference information to ensure that designer intent is not lost.

Thus, by saving the pixel size of a component and pixel size of the viewport, document renderer 81 may keep the design intention. For example, if “100 px” and “1000 px” are saved accordingly by document converter 32 and document renderer 81 may render 10 cwq or 10%. Since the 10% difference is saved in the document representation language, it cannot be later rendered at 10 cqw.

It will be further appreciated that CSS style properties that are scaled proportionally may use DIRPS as a multiplication of the regular px value.

In a further embodiment, to facilitate editing, during stage editing (possibly until preview), any DIRPs may be treated as frozen, so the editing is done in px (in other words, during editing, 1 spx=1 px).

It will be further appreciated that for the application of maximum/minimum width for container components or for embedding a site part in other websites, scale proportionality may be disabled recursively down. It will be appreciated that the CSS variable of for the spx unit may be set to a constant value on a container, and therefore may be propagated to all descendants with the container. Alternatively, the container may be set as a new “queried container” so that it may be used as a reference size for any descendants. Therefore, if there is a set min/max size value, the descendant would have a min/max size, since it is derived from the container's size.

In the disabled embodiment, the reference point (container type: inline size) defined at the component level, may be changed and document renderer 81 may save the measurement of the reference container along with the container when it is rendered or when it is saved or published.

It will be appreciated that there may be different CSS implementations. Since DIRP is an abstract unit of measurement, it can be used to resolve other scaling issues in different modes. For example, it can solve the issue of font size being too small on a mobile device. In this scenario, font size can be set to be at least 12 px on mobile devices for components with a DIRP property.

It will be further appreciated that in the case of an override in size from a different viewport size, workable solutions may include keeping the reference width along with any change or keeping the change within a certain context of the document.

In another embodiment a different reference context may be used (i.e., not screen width). An example is embedding a site part in another site for min/max width. In this scenario, the “queried container” width would need to be measured or pre-determined.

In another embodiment, for a blocks editor or an editor for website building system configurable applications (as described in U.S. Pat. No. 11,698,944 entitled “System and Method for Creation and Handling of Configurable Applications for Website Building Systems” granted 11 Jul. 2023, commonly owned by the Applicant and incorporated herein by reference) which have no sections, there is a need to set a specific pre-determined pixel reference size instead of a screen width to be kept with the widget. In this scenario, the blocks editor may implement support in DIRPs.

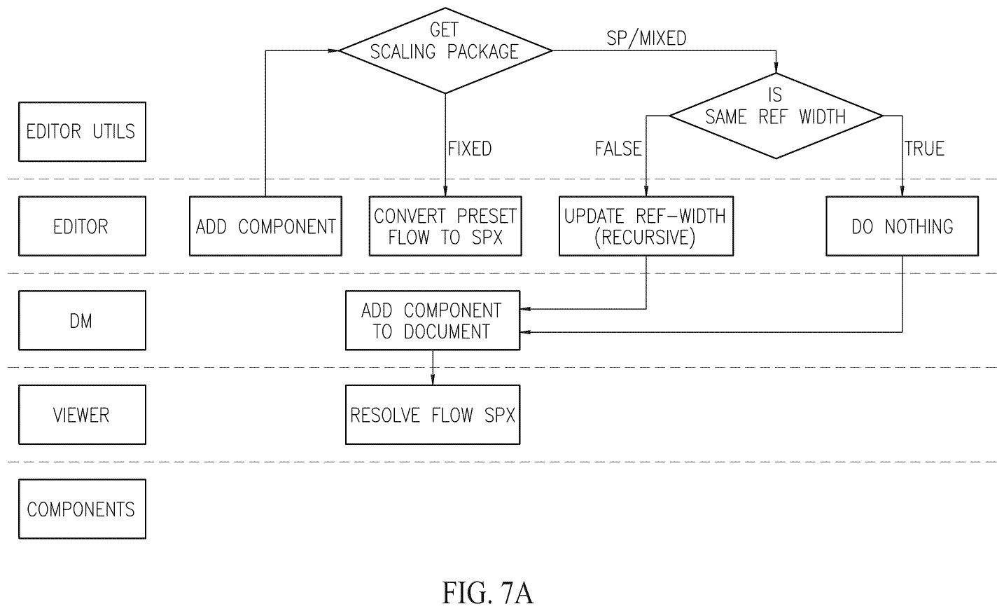

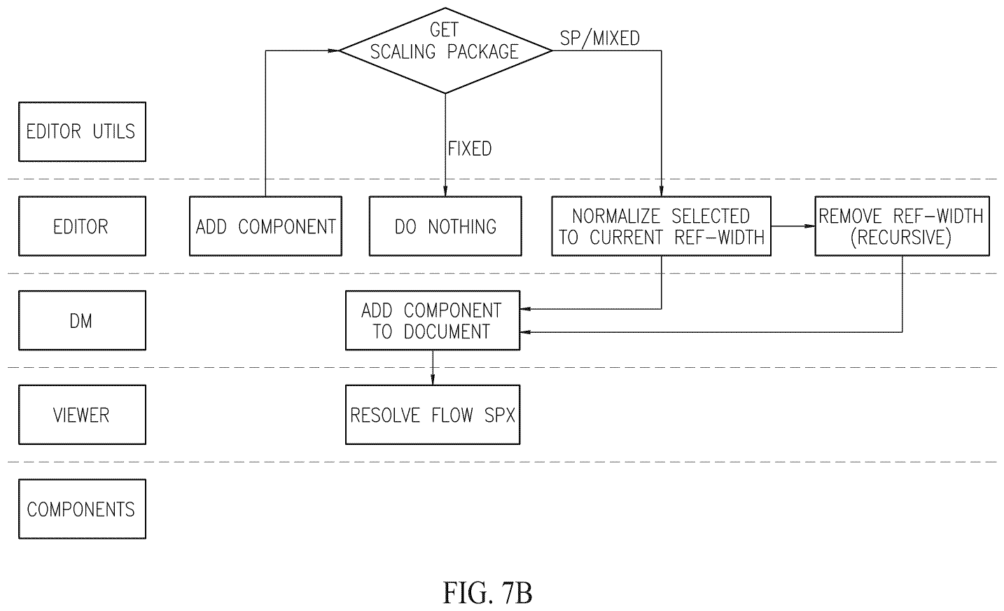

Reference is now made to FIGS. 7A and 7B which represent different algorithms and flows that may be implemented by system 200 to apply scaling. They both illustrate scenarios where responsive website components are not all set to spx values and need to create a harmonic responsive behavior to keep as much design intention as possible. FIG. 7A illustrates adding/pasting/attaching a component to another component that has spx behavior defined. FIG. 7B illustrates adding/pasting/attaching a component to another component that has either “fixed” or “min/max” responsive behavior (i.e., not spx). “Fixed” in this context means set to constant pixel value and not scaling with screen width changes. “min/max” means scaling with screen size but within a minimum and maximum range (of physical size or pixels).

It will be appreciated that since the reference viewport width is always known, different actions may be implemented without having to determine the reference viewport each time. This may enable components to be added in one context and added to another (such as copy while on mobile screen width and paste in desktop screen width). If the user intent is changed, the px values may be normalized by the designer or ML/AI engine 82 according to the scenario.

Reference is now made to FIG. 7A which illustrates the flow for adding anew component and reparenting to a DIRP. The scaling package is retrieved to check the responsive behavior for the component to be added. If the behavior is set as fixed, then it is a constant sized component, and the preset flow is converted to spx. If the behavior is set as spx for some or all of the properties, then a check is made to see if the added component spx and the target set component have the same reference width reference size. If yes, then the flow of activity is continued. If the reference screen width is different, the spx unit size is kept and the reference width size is changed to be the reference width size of the target container for the added component and any descendent components recursively. The component is then added to the document and document renderer 81 may resolve any sizing according to the data set in the document.

Reference is now made to FIG. 7B which illustrates adding a component to a fixed or minimum/maximum target. The scaling package is retrieved to check for the defined responsive behavior for the added component. If the behavior is set as fixed, then a constant-sized component is being added or moved to a variable-sized component and the regular flow is continued. If the behavior is set as spx for all or some of the properties, then the added component size is normalized to the current screen width. For example, if it was set to 100 spx for a 1000 px screen width and the current screen width is 2000 px, set it to 200 spx in 2000 px screen width. The reference screen width of the added component and its descendants are removed recursively. For example, if the value in the document is 200 spx without screen width reference, the designer last saw the component rendered at 200 px and originally wanted it to scale. Since it is being entered into an area that does not scale, it is prevented from being scaled in the current scenario so that it doesn't break the original design. The component is then added to the document and rendered. In this scenario document renderer 81 may resolve size issues according to the data set in the document.

Thus, by using a new unit of designer intended rendered pixel which may be based on display pixels and measurements of a reference viewport (on which a site was created). The same website may be re-rendered on other viewports without the need for breakpoint value and preserving context, user intent, typography, and original layout.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

Embodiments of the present invention may include apparatus for performing the operations herein. This apparatus may be specially constructed for the desired purposes, or it may comprise a computing device or system typically having at least one processor and at least one memory, selectively activated or reconfigured by a computer program stored in the computer. The resultant apparatus when instructed by software may turn the general purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus. The computer readable storage medium may also be implemented in cloud storage.

Some general purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A website building system (WBS), the system comprising:
an editor to enable a designer of said WBS to create and edit a website on a first sized viewport, said website having at least one component having at least one property with a display pixel value for a measurement of said first sized viewport represented as a designer intent responsive pixel (DIRP), said editor to save a representation of said website according to an original layout of said website;
a scaling pixel handler to render said representation onto a second sized viewport and to display said at least one component proportionally as scaled version of said DIRP according to a measurement of said second sized viewport; and
wherein said rendered representation maintains said original layout.

2. The system according to claim 1 wherein said at least one component comprises at least one of: page, a section, a mini-page, a regular container, a single-page container, a multi-page container and a gallery container.

3. The system according to claim 1, wherein said editor comprises:
a visual editor to enable said editing using a stage and panels; and
a document converter to save said representation using a data representation language.

4. The system according to claim 1, wherein said scaling pixel handler comprises:
a document renderer to convert said representation to CSS properties for said display according to said original layout; and
a machine learning (ML)/artificial intelligence (AI) engine to provide recommendations and overrides for said document renderer.

5. The system according to claim 4, wherein said document renderer comprises a designer intent responsive pixel (DIRP) calculator to scale said DIRPs according to said measurement of said second sized viewport.

6. The system according to claim 1, wherein said measurement is width or height.

7. The system according to claim 1, wherein said at least one property is at least one of: font size, corner radius, border width and box shadow.

8. The system according to claim 1, wherein said original layout comprises a typography of said website.

9. A method for a website building system (WBS), the method comprising:
enabling a designer of said WBS to create and edit a website on a first sized viewport, said website having at least one component having at least one property with a display pixel value for a measurement of said first sized viewport represented as a designer intent responsive pixel (DIRP);
saving a representation of said website according to an original layout of said website;
rendering said representation onto a second sized viewport;
displaying said at least one component proportionally as scaled version of said DIRP according to a measurement of said second sized viewport; and
wherein said rendered representation maintains said original layout.

10. The method according to claim 9, wherein said at least one component comprises at least one of: page, a section, a mini-page, a regular container, a single-page container, a multi-page container and a gallery container.

11. The method according to claim 9, wherein said enabling a designer comprises:
enabling editing using a stage and panels; and
saving said representation using a data representation language.

12. The method according to claim 9, wherein said rendering comprises:
converting said representation to CSS properties for said display according to said original layout; and
using machine learning (ML)/artificial intelligence (AI) engine to provide recommendations and overrides for said converting.

13. The method according to claim 12, wherein said converting comprises a designer intent responsive pixel (DIRP) calculator to scale said DIRPs according to said measurement of said second sized viewport.

14. The method according to claim 9, wherein said measurement is width or height.

15. The method according to claim 9, wherein said at least one property is at least one of: font size, corner radius, border width and box shadow.

16. The method according to claim 9, wherein said original layout comprises a typography of said website.

17. A system for providing specialized size units in responsive editing, comprising:
a scaling pixel handler configured to:
receive a document defining a website layout using designer intent responsive pixels (DIRPs), wherein each DIRP is associated with a reference viewport size;
render the document into Cascading Style Sheets (CSS) by converting the DIRPs to CSS units based at least on a current viewport size; and
output said rendered CSS for display of the website layout across different viewport sizes while preserving designer intent and typography consistency.

18. The system of claim 17, wherein the scaling pixel handler is further configured to:
receive a user input specifying a custom viewport size; and
dynamically update said rendered CSS based on said custom viewport size.

19. The system of claim 2, wherein dynamically updating the rendered CSS comprises recalculating said conversion of DIRPs to CSS units based on a ratio between the custom viewport size and said reference viewport size.

20. The system of claim 1, wherein the scaling pixel handler is further configured to maintain a consistent typography scale across different viewport sizes by applying a scaling factor to font sizes defined using DIRPs.
